(19) United States
(12) Patent Application Publication
(10) Pub. No.: US 2024/0250964 A1
(43) Pub. Date: Jul. 25, 2024

(54) ALERT VERIFICATION DEVICE, ALERT VERIFICATION METHOD, AND ALERT VERIFICATION PROGRAM

(71) Applicant: NIPPON TELEGRAPH AND TELEPHONE CORPORATION, Tokyo (JP)

(72) Inventors: Kunio MIYAMOTO, Tokyo (JP); Yuta IWAKI, Tokyo (JP); Yo KANEMOTO, Tokyo (JP); Kotomi KUROKI, Tokyo (JP)

(73) Assignee: NIPPON TELEGRAPH AND TELEPHONE CORPORATION, Tokyo (JP)

(21) Appl. No.: 18/570,046

(22) PCT Filed: Jun. 14, 2021
(86) PCT No.: PCT/JP2021/022590

§ 371 Date: Dec. 13, 2023

(51) Int. Cl. H04L 9/40

(52) U.S. Cl. CPC H04L 63/1416

(57) ABSTRACT

A reception unit (131) receives an alert transmitted from an attack detection apparatus (3) that detects an attack on a monitoring target device. A generation unit (132) generates an acquisition condition of communication data to be acquired on the basis of the alert received by the reception unit (131). An acquisition unit (133) acquires the communication data matching the acquisition condition generated by the generation unit (132) from a packet capture device (4) holding data transmitted and received by the monitoring target device. A success/failure determination unit (125) determines success or failure of an attack on the basis of the communication data acquired by the acquisition unit (133).

### TECHNICAL FIELD

The present invention relates to an alert verification device, an alert verification method, and an alert verification program.

### BACKGROUND ART

Web applications are used in many services, and can be accessed from an unspecified number of persons. Therefore, the web application has a property of being easily exposed to an attack. Attacks to the web applications are generated in large quantities daily and detected by a security apparatus or the like.

As the attack detection technique, there are techniques such as WAF (Web Application Firewall) and NIDS (Network-based Intrusion Detection System). These techniques are techniques for detecting communication matching features of attack codes held in advance as an attack from network communication.

However, these techniques can detect an attack, but it is difficult to automatically determine whether or not the detected attack has been successful, and a large number of alerts must be manually investigated in order to determine the success or failure of an attack.

Therefore, various techniques for verifying whether or not an attack is successful have been studied. For example, there is a technique called HIDS (Host-based Intrusion Detection System) which detects an attack by applying an abnormality detection technique using characteristics in a server such as file access and DB (Data Base) access and which indicates that the attack is successful when an abnormality is detected. Also, there is a technique called stateful IDS which defines a state transition when an attack is successful and detects that the attack is successful when the system performs the defined state transition by the attack (“A Stateful Intrusion Detection System for World-WideWeb Servers”, ACSAC, 2003, “Enhancing Byte-Level Network Intrusion Detection Signatures with Context”, CCS, 2003, “Verify Results of Network Intrusion Alerts Using Lightweight Protocol Analysis”, ACSAC, 2005). Further, there is a method called a correlation analysis with vulnerability information in which it is checked in advance whether or not an application and a version to which an attack deals are used, and if it is determined that the attack is used, and it is detected that the attack is successful (refer to “Alert Verification Determining the Success of Intrusion Attempts”, DIMVA, 2004). Further, there is a technique called emulation of an attack code for detecting success of an attack when emulating the attack code and observing the same behavior at the time of execution (refer to “On Emulation-Based Network Intrusion Detection Systems”, RAID, 2014).

Further, the following techniques have been proposed as the conventional art for determining whether or not the attack to the server by the attack code has been successful. One is a technique for executing emulation of an attack to a server according to the determined attack type, extracting a feature appearing in a response when the attack to the server is successful, and determining that the attack by an attack code is successful when the response from the server has the extracted feature. In addition, there is a technique for extracting a feature of a response when the attack is successful by executing emulation of the attack to the server according to the attack type, and determining that the attack is successful when at least one of a plurality of responses after the attack request has the extracted feature.

The processes in the conventional art are executed as follows, for example. First, it is determined whether the request is an attack or not. When the request is not an attack, it is determined that the attack success/failure determination is impossible. When the request is an attack, determination processing of an attack type is performed determination whether or not the attack type can be determined. When the attack type is not determined, it is determined that the attack success/failure determination is impossible. On the other hand, when the attack type can be determined, the attack code is analyzed and a feature corresponding to the attack code is selected from features appearing in the response. Then, it is determined whether or not the selected feature exists. If the selected feature does not exist, it is determined that the attack success/failure determination is impossible. On the other hand, when the selected feature exists, inspection processing of the feature is performed, it is determined whether the attack is successful or not, and the success or failure of the attack is notified by the determination result.

The device for performing the attack success/failure determination processing as described above includes, for example, an attack detection unit, an attack type determination unit, an attack code analysis unit, a feature selection unit and a feature inspection unit. The attack detection unit detects whether or not the request is an attack. The attack type determination unit determines the type of attack from the programming language of the attack code and the method of attack by using a keyword list held in advance. The attack code analysis unit prepares an emulator capable of executing an attack code according to an attack type by using a keyword list and a feature candidate DB held in advance, and executes the attack code by the emulator. The feature selection unit excludes features which are not suitable for handling as features at the time of success of attack from the obtained feature candidates by using a response DB in which information of response is stored and a feature DB in which information of features at the time of success of attack is stored. The feature inspection unit inspects whether or not a feature to be output when the attack code obtained by the attack code analysis unit is executed is included in communication or the like by using the feature DB. The technique for determining whether or not the attack to the server by the attack code has been successful is hereinafter referred to as an alert verification technique.

### CITATION LIST

### Patent Literature

[PTL 1] WO 2019/013266
[PTL 2] WO 2019/225216

### SUMMARY OF INVENTION

### Technical Problem

However, the alert verification technique has the following problems. Packets of communications not detected as an attack are also performed parsing processing into HTTP requests or HTTP responses by the implementation device of the alert verification technique. That is, in the implementation device of the alert verification technique, a communication packet is performed parsing processing for an HTTP request or an HTTP response, and whether or not the communication packet is attack communication is determined by using information of an attack detection apparatus such as WAF. Therefore, in a large amount traffic environment, the load of the parsing processing is increased, and the processing of the alert verification technique is greatly delayed. In this case, all the communication packets are parsed into HTTP request or HTTP responses, but the communication that is a target of the attack success/failure determination in the alert verification technique is the communication that is determined to be an attack.

The present invention was made in view of the above description, and an object of the present invention is to reduce the processing load of an attack determination processing by reducing parsing processing of communication packets.

### Solution to Problem

In order to solve the problem described above and to achieve an object, a reception unit receives an alert transmitted from an attack detection apparatus that detects an attack on a monitoring target device. A generation unit generates an acquisition condition of communication data to be acquired on the basis of the alert received by the reception unit. An acquisition unit acquires the communication data matching the acquisition condition generated by the generation unit from a packet capture device holding data transmitted and received by the monitoring target device. A success/failure determination unit determines success or failure of an attack on the basis of the communication data acquired by the acquisition unit.

### Advantageous Effects of Invention

According to the present invention, the parsing processing of the communication packet can be reduced, and the processing load of the attack determination processing can be reduced.

### BRIEF DESCRIPTION OF DRAWINGS

FIG. 1 is a schematic configuration diagram of a system in which an alert verification device is arranged.

FIG. 2 is a block diagram of a determination device according to a first embodiment.

FIG. 3 is a diagram showing an example of an attack type keyword list.

FIG. 4 is a flowchart of an attack success/failure determination processing by a determination device according to the first embodiment.

FIG. 5 is a diagram showing a second order attack according to a second embodiment.

FIG. 6 shows an attack across a plurality of sessions in a third embodiment.

FIG. 7 is a diagram showing a login bypass attack according to a fourth embodiment.

FIG. 8 is a system configuration diagram according to a sixth embodiment.

FIG. 9 shows an example of a computer executing an alert verification program for the attack success/failure determination processing.

### DESCRIPTION OF EMBODIMENTS

Hereinafter, embodiments of an alert verification device, an alert verification method, and an alert verification program disclosed in the present application will be described in detail with reference to the drawings. Note that the alert verification device, the alert verification method, and the alert verification program disclosed in the present application are not limited to the following embodiments.

### First Embodiment

### [Overview]

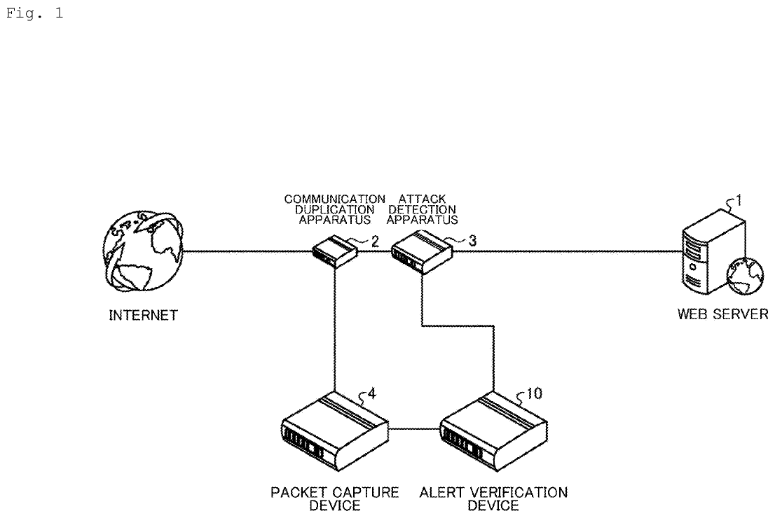

FIG. 1 is a schematic configuration diagram of a system in which an alert verification device is arranged. As shown in FIG. 1, a communication duplication apparatus 2 and an attack detection apparatus 3 are arranged on a communication path connected from the Internet to the web server 1. Further, a packet capture device 4 is connected to the communication duplication apparatus 2. The alert verification device 10 is connected to an attack detection apparatus 3 arranged on a communication path connected to the packet capture device 4 and the web server 1. The configuration in which the alert verification device 10 is connected to the attack detection apparatus 3 via a path different from a path connected to the web server 1 is called a tap configuration.

A web application operating in the web server 1 performs communication such as reception of a request and transmission of a response, and transmission of a request and reception of a response with a PC or the like connected to the Internet. In the present embodiment, the communication to the web application will be described, but in the following description, the communication to the web application operating in the web server 1 will be simply referred to as the communication to the web server 1. A request from the Internet to the web server 1 may include an attack request.

The communication duplication apparatus 2 duplicates traffic to the web server 1. In other words, the communication duplication apparatus 2 receives communication data transmitted and received between a PC or the like connected to the Internet and the web server 1 to generate a duplication. Then, the communication duplication apparatus 2 transmits the duplicated communication data to the packet capture device 4.

The packet capture device 4 receives a copy of communication data transmitted and received between a PC or the like connected to the Internet and the web server 1 generated by the communication duplication apparatus 2. Then, the packet capture device 4 stores and holds the acquired communication data.

The attack detection apparatus 3 is a device having a function of detecting an attack request from network communication by using a technique such as WAF. When receiving an attack request transmitted from the Internet to the web server 1, the attack detection apparatus 3 generates an alert indicating the attack request and transmits the alert to the alert verification device 10. The alert includes, for example, an IP (Internet Protocol) address, a port number and a path portion of URL (Uniform Resource Locator) of a transmission source of the attack request.

When an attack is detected, the alert verification device 10 receives an alert indicating the attack detection from the attack detection apparatus 3. Then, the alert verification device 10 acquires communication data associated with the alert from the packet capture device 4. Then, the alert verification device 10 executes an attack code by an emulator corresponding to an attack type (for example, an attack type for abusing an OS (operating system) command) specified from the acquired communication data, and extracts the result of the execution as a feature output from the web server 1 when the attack succeeds.

Thereafter, the alert verification device 10 inspects a response from the web server 1, and when the extracted feature is included in the response, it is determined that the attack is successful. Here, in the alert verification device 10, when there is an attack request to the web server 1, the extracted feature is not only a response to the attack request but also a response thereafter, all responses meeting a predetermined condition may be subjects to inspection.

In this way, the alert verification device 10 can reduce the parsing processing load of the communication packet by acquiring the communication data to be an object of attack success/failure determination from the packet capture device 4 and suppressing the acquisition of other communication data.

### [Configuration of Determination Device]

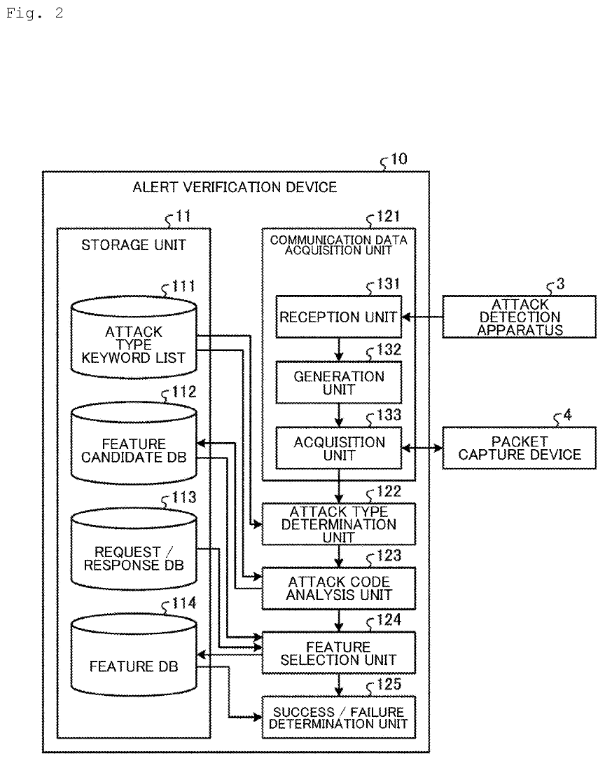

FIG. 2 is a block diagram of a determination device according to a first embodiment. As shown in FIG. 2, an alert verification device 10 according to the present embodiment includes a storage unit 11, a communication data acquisition unit 121, an attack type determination unit 122, an attack code analysis unit 123, a feature selection unit 124, and a success/failure determination unit 125. A storage unit 11 stores an attack type keyword list 111, a feature candidate DB 112, a request/response DB 113, and a feature DB 114.

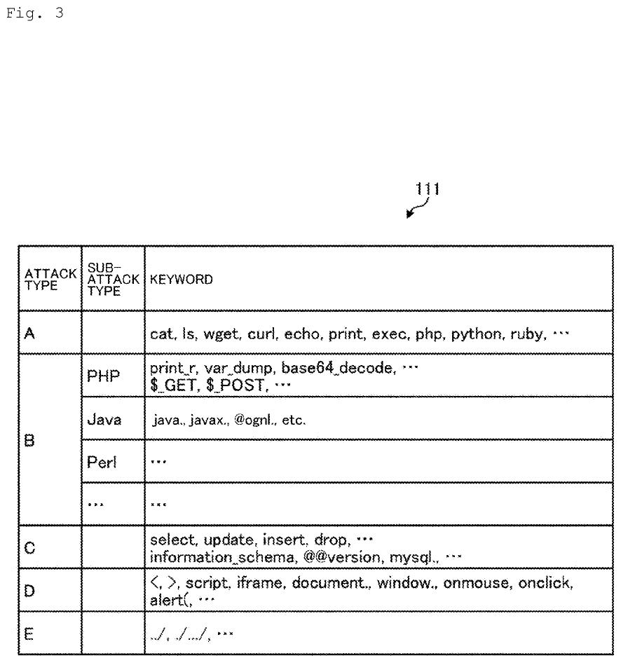

The attack type keyword list 111 is information indicating keywords included in the attack code of each attack type for each attack type. FIG. 3 is a diagram showing an example of an attack type keyword list. The attack type keyword list 111 is referred to when the attack type determination unit 122 determines the attack type from the keyword included in the attack code.

Note that the attack type is, for example, A. attack type that abusing OS commands, B. attack type that exploits program code, C. attack type for abusing the SQL (Structured Query Language) command, which is a function of the DB (for example, SQL Injection, etc.), D. attack type for abusing HTTP (Hyper Text Transfer Protocol) responses (for example, XSS (Cross Site Scripting), Header Injection, etc.), E. attack type for abusing file operations (for example, directory traversal, etc.) are classified into five types.

As illustrated in FIG. 3, in the attack type of A. described above, the name of the OS command is used as a keyword. In the case of the attack type of B., the specific expression used in the programming language is used as a keyword. For example, in the case of a PHP (Hypertext Preprocessor), a function specific to PHP such as print_r, var_dump, base64_decode, or a specific expression of PHP ($ GET, $_POST, or the like) is used as a keyword. The same is also applied to other programming languages (Java (registered trademark), Perl, Ruby, Python, etc.). For this reason, in the case of the attack type of B., the attack type keyword list 111 is held for each programming language. At this time, information indicating which programming language corresponds to is held as a sub-attack type, for example, as shown in FIG. 3.

In the case of the attack type of C., the name of the SQL command (select, update, insert, drop, etc.) and the characteristic representation in the case of DB access are used as keywords. For example, in the case of MySQL, it is information schema, @@version, mysql, etc. In addition, in the attack type of D., a specific expression (alert, onclick, etc.) used in HTML (HyperText Markup Language) or Javascript (registered trademark) is used as a keyword. In the case of the attack type of E., specific expressions (../, or the like) used in the directory traversal attack are used as keywords.

Returning to FIG. 2, the description will be continued. A feature candidate DB 112 stores information (feature candidates) output from the emulator as a result of emulation of the attack code by the attack code analysis unit 123.

A request/response DB 113 stores various requests to the web server 1 and various responses from the web server 1. The request/response DB 113 may also store information for the feature selection unit 124 to be referred to when the feature selection unit 124 excludes words (universal words) frequently appearing in the normal response from the feature candidates. In this case, the request/response DB 113 is created, for example, by acquiring a response in a test environment that is guaranteed not to be attacked. Alternatively, the response is created by using a response corresponding to a request not detected by the attack detection apparatus 3.

A feature DB 114 stores features output from the web server 1 when the attack by the attack code succeeds. Specifically, the feature DB 114 stores the feature selected by the feature selection unit 124 from among feature candidates stored in the feature candidate DB 112. The features stored in the feature DB 114 are referred to when a success/failure determination unit 125 determines whether or not the attack is successful on the basis of a response from the web server 1.

The communication data acquisition unit 121 executes an alert reception processing described below. The communication data acquisition unit 121 receives an alert issued by the attack detection apparatus 3 and executes alert reception processing for generating an acquisition condition of communication data associated with the alert. Then, the communication data acquisition unit 121 executes communication data acquisition processing for acquiring communication data corresponding to the generated acquisition condition from the packet capture device 4. More specifically, the communication data acquisition unit 121 includes a reception unit 131, a generation unit 132, and an acquisition unit 133.

When the attack to the web server 1 is detected by the attack detection apparatus 3, the reception unit 131 receives an alert for notifying the attack detection from the attack detection apparatus 3. That is, the reception unit 131 receives an alert transmitted from the attack detection apparatus 3 that detects an attack on the web server 1 as a monitoring target device and generates the alert. And the reception unit 131 outputs the received alert to the generation unit 132.

The generation unit 132 receives an input of an alert issued by the attack detection apparatus 3 from the reception unit 131. Next, the generation unit 132 extracts information capable of specifying communication data associated with the alert from the alert. For example, included in the alert, the generation unit 132 extracts an IP address and a port number of a transmission source of the attack request, and a part or all of a path portion or the like of the URL.

Next, the generation unit 132 generates an acquisition condition of the communication data by using information capable of specifying the communication data associated with the alert. For example, included in the alert, the generation unit 132 uses an IP address and a port number of a transmission source of the attack request, and a part or all of a path portion or the like of the URL, and generates the acquisition condition for acquiring communication data related to them. After that, the generation unit 132 outputs the generated an acquisition condition to the acquisition unit 133. That is, the generation unit 132 generates an acquisition condition of communication data to be acquired on the basis of the alert received by the reception unit 131.

An acquisition unit 133 transmits the acquisition condition generated by the generation unit 132 to the packet capture device 4, and requests acquisition of communication data matching the acquisition condition. Then, the acquisition unit 133 receives communication data matching the transmitted acquisition condition from the packet capture device 4. That is, the acquisition unit 133 acquires communication data matching the acquisition condition generated by the generation unit 132 from a packet capture device 4 holding data transmitted and received by a web server 1 being a monitoring target device. Thereafter, the acquisition unit 133 outputs communication data matching the acquisition condition, that is, communication data associated with an alert to the attack type determination unit 122.

An attack type determination unit 122 receives input of communication data associated with an alert from an acquisition unit 133 of a communication data acquisition unit 121. Then, an attack type determination unit 122 extracts an attack code included in the acquired communication data. Thereafter, an attack type determination unit 122 determines an attack type by using the extracted attack code.

Here, the attack type determination unit 122 determines which of five attack types of the attack types of A. to E. described above, which are considered to be particularly important among attacks on the web server 1, for example. More specifically, the attack type determination unit 122 determines whether a keyword included in the attack code matches with which attack type keyword shown in the attack type keyword list 111.

For example, the attack type determination unit 122 refers to the attack type keyword list 111 and determines the attack code as the attack type of A. (an attack type for abusing an OS command) if “cat” is included in the attack code. When the attack code includes “print_r”, the attack type determination unit 122 determines that the attack code is the attack type of B. (an attack type in which a program code is abused), and that the attack code is an attack type using php among them.

When an attack code matches the keywords of the plurality of attack types shown in the attack type keyword list 111, the attack type determination unit 122 determines the attack type according to a predetermined condition. For example, the attack type determination unit 122 determines that the attack type of the keyword appearing at the leftmost position within the attack code at the beginning of the attack code.

For example, the attack code is “;php -e “$i=123456789;var_dump($1)”;” in the case of the attack type, “php” which is a keyword of the attack type of A. and “var_dump”, which is a keyword of the attack type of B. appear in the attack type keyword list 111. In such a case, the attack type determination unit 122 determines the attack type of A. since “php” appears earlier than “var_dump” in the above-mentioned attack code.

Note that the attack type determination unit 122 refers to the attack type keyword list 111 and determines that determination is not possible when the attack code does not match any attack type. After that, the attack type determination unit 122 notifies the attack code analysis unit 123 of the attack code included in the attack request and the attack type of the attack code.

An attack code analysis unit 123 performs dynamic analysis using an emulator for the attack code to extract features appearing in a response from the web server 1 when the attack code is executed.

Specifically, the attack code analysis unit 123 uses an emulator corresponding to the attack type of the attack code determined by the attack type determination unit 122 to emulate the attack to the web server 1 by the attack code. Then, the attack code analysis unit 123 extracts an output appearing in a response to an attack in emulation of the attack code as a feature candidate appearing when the attack succeeds.

Further, the emulator corresponding to each attack type described above is created in advance by applying a debugger or an interpreter, for example, and the attack code analysis unit 123 selects the emulator corresponding to the attack type from the emulators created in advance.

Next, the attack code analysis unit 123 extracts, for example, features appearing in the response to the request when the attack code is executed as follows.

For example, when the attack type of the attack code is A. an attack type for abusing an OS command, the attack code analysis unit 123 executes the attack code as a command by using an environment capable of executing the OS command. As an environment in which the OS command can be executed, for example, a command prompt of Windows (registered trademark), a bash of Linux (registered trademark), or an emulator capable of emulating the command can be used.

For example, the attack code analysis unit 123 causes the bash command to execute the command specified by the -c argument, such as “bash -c “cat/etc/passwd;”. Then, the attack code analysis unit 123 extracts the contents of the standard output and the standard error output by the execution of the command as feature candidates. For example, the attack code analysis unit 123 extracts information in which standard output is “root:*:0:/bin/sh . . . ” and standard error output is “not applicable”, for the attack code “cat/etc/passwd;” as feature candidates.

Also, for example, when the attack type of the attack code is B. an attack type for abusing the program code, the attack code analysis unit 123 executes the attack code using an interpreter or emulator suitable for the programming language.

To give an example, when the attack code is a php code, the attack code analysis unit 123 causes the php interpreter to execute the codes designated by the -r argument, such as “php -r “print(‘123456789’);die( );””. When the attack code is a python code, the attack code analysis unit 123 causes the python interpreter to execute the codes designated by the -c argument, such as “python -c “import sys;print 123456789;sys.exit( )””.

Then, the attack code analysis unit 123 extracts the contents of the standard output and the standard error output as feature candidates after executing the code. For example, in the case of a php code, the attack code analysis unit 123 extracts information in which standard output is “123456789” and standard error output is “not applicable”, for the attack code “print(‘123456789’);die( );” as feature candidates.

When the attack type of the attack code is C. the attack type for abusing the SQL command, the attack code analysis unit 123 uses a terminal or an emulator capable of executing the SQL statement to the DB, and an attack code is executed.

Note that the SQL statement (SQL command) inserted by the SQL Injection attack is partial and cannot be executed as it is. Therefore, the attack code analysis unit 123 shapes the SQL statement. For example, by deleting a portion preceding at the SELECT clause or the like of the SQL statement, the attack code analysis unit 123 changes the SQL statement so that the SELECT clause or the like appears at the beginning of the attack code. The keywords that the attack code analysis unit 123 adjusts to appear first among the clauses of the SQL statement may be clauses other than the SELECT clause, such as clauses of update, delete, drop, etc., and it is assumed that these clauses are given in the attack type keyword list 111.

An attack code analysis unit 123 extracts contents of standard output and standard error output by execution of the SQL statement after forming as feature candidates. For example, the attack code analysis unit 123 forms the attack code “‘union select 123456789-” into “select 123456789”. Then, the attack code analysis unit 123 extracts information on standard output “123456789” and standard error output “not applicable” by execution attack code after forming as feature candidates.

When the attack type of the attack code is D. an attack type for abusing the HTTP response, the attack code analysis unit 123 analyzes, in terms of the nature of the attack, since the attack code itself is sent to the client as a response, the attack code itself is extracted as a feature candidate.

For example, when the attack code is an attack code “<script>alert(1)</script>” by XSS, the attack code analysis unit 123 extracts “<script>alert(1)</script>” as a feature candidate. If the attack code is the attack code “YrYnSet-Cookie:1234;” by Header Injection, the attack code analysis unit 123 extracts “YrYnSet-Cookie:1234;” as a feature candidate.

If the attack type of the attack code is E. the attack type for abusing file operations (for example, directory traversal), the attack code analysis unit 123 searches for file names appearing in the attack code in the OS and extracts the contents of files with those file names as feature candidates.

For example, when the attack code is “../../../../etc/passwd”, the attack code analysis unit 123 extracts “root:*:0:/bin/sh . . . ”, which is the content of the file with the file name appearing in the attack code searched from within the OS, as a feature candidate.

Thus, the attack code analysis unit 123 executes emulation according to the attack type of the attack code, and can extract a feature candidate which is a feature when the attack by the attack code succeeds. Then, the attack code analysis unit 123 stores the extracted feature candidates in a feature candidate DB 112.

The feature selection unit 124 excludes inappropriate candidates as features from the feature candidates extracted by the attack code analysis unit 123. Specifically, the feature selection unit 124 excludes feature candidates that are too universal and highly likely to be unusable for determining the success or failure of an attack from among the feature candidates stored in the feature candidate DB 112.

For example, the feature selection unit 124 excludes feature candidates having extremely short character string length such as character string length of 2 or less from feature candidates stored in the feature candidate DB 112. Further, the feature selection unit 124 excludes feature candidates of a universal word appearing also in a normal response from the feature candidates. Then, a feature selection unit 124 stores the remaining feature candidates in a feature DB 114 as features at the time of successful attack.

For example, the feature selection unit 124 excludes feature candidates “1, 2” whose character string length is equal to or less than a predetermined value (for example, 2) from feature candidates “1, 2, title, page, 123456789”. Thereafter, a feature selection unit 124 excludes the universal word from “title, page, 123456789” excluding feature candidates whose character string length is equal to or less than a predetermined value.

Here, it is assumed that the universal word is, for example, a word included in a response to a request which is not an attack. Therefore, the feature selection unit 124 refers to the request/response DB 113 and excludes feature candidates whose number of appearances in the request/response DB 113 is 1 or more among the feature candidates “title, page, 123456789”. Then, a feature selection unit 124 stores the feature candidates in which the exclusion result is left as features at the time of success in the attack in a feature DB 114.

As an example, it will be explained the case where a response “<html><title>My blog page</title><p>Hello world! Date: 2017 Apr. 1</p></html>” is stored in the request/response DB 113. In this case, the feature selection unit 124 excludes feature candidates “title, page”, which appears in the response, among feature candidates “title, page, 123456789”. Then, a feature selection unit 124 stores the feature candidate “123456789” in which the exclusion result is left in a feature DB 114 as a feature when the attack is successful.

Here, in the present embodiment, the feature selection unit 124 uses the request/response DB 113 when excluding the universal word from the feature candidate DB 112, and a list of prepared universal words may be used. Also, the feature selection unit 124 may perform both the exclusion of feature candidates having extremely short character string lengths and the exclusion of feature candidates of universal words, as described above, with respect to the feature candidates extracted by the attack code analysis unit 123, or only one of them may be performed.

A success/failure determination unit 125 refers to the feature DB 114 to determine whether or not a response from the web server 1 indicates success of an attack. That is, the success/failure determination unit 125 determines that the attack is successful when the response includes the feature stored in the feature DB 114. On the other hand, when the response does not include the feature stored in the feature DB 114, a success/failure determination unit 125 determines that the attack has failed. That is, the success/failure determination unit 125 determines success or failure of the attack on the basis of the communication data acquired by the acquisition unit 133. Then, the success/failure determination unit 125 outputs the determination result of the success/failure of the attack.

Here, the success/failure determination unit 125 may inspect each of the multiple responses corresponding to each of the multiple requests to the web server 1 after the attack request to see if each of them has the extracted features, and if at least any one of the multiple responses has the extracted features, it may determine that the attack by the attack code was successful.

### [Determination Processing Procedure of Success or Failure of Attack]

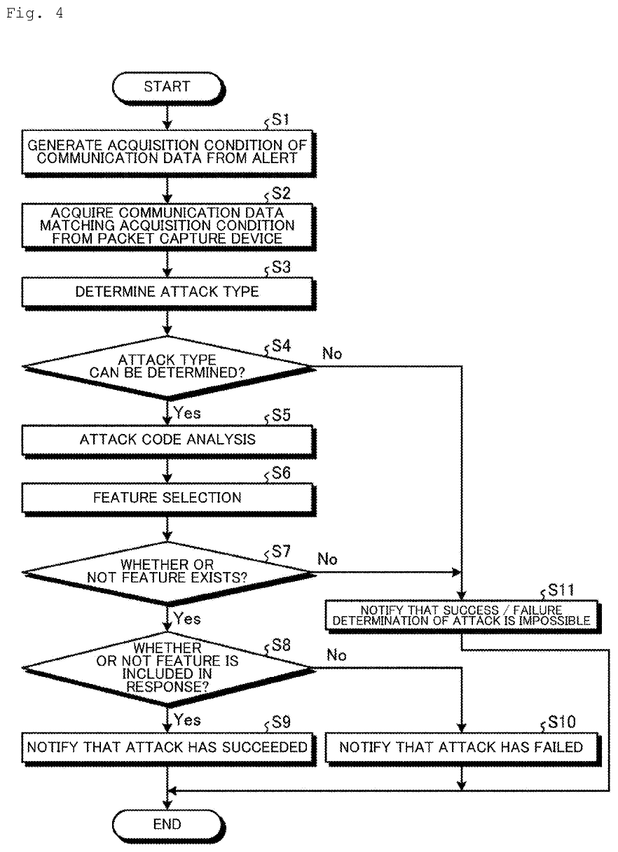

FIG. 4 is a flowchart of an attack success/failure determination processing by a determination device according to the first embodiment. Next, the flow of attack success/failure determination processing by the alert verification device 10 according to the present embodiment will be described with reference to FIG. 4.

The reception unit 131 of a communication data acquisition unit 121 receives an alert from the attack detection apparatus 3 when the attack detection apparatus 3 detects an attack to the web server 1. The generation unit 132 of the communication data acquisition unit 121 generates an acquisition condition of the communication data from the alert acquired by the reception unit 131 (step S1).

Next, the acquisition unit 133 of the communication data acquisition unit 121 acquires communication data matching the acquisition condition generated by the generation unit 132 from the packet capture device 4 (step S2). Thereafter, the acquisition unit 133 of the communication data acquisition unit 121 outputs the acquired communication data to the attack type determination unit 122 as communication data associated with an alert.

The attack type determination unit 122 refers to the attack type keyword list 111 to determine an attack type of an attack code included in the communication data acquired by the communication data acquisition unit 121 (step S3).

The attack type determination unit 122 determines whether or not the attack type can be determined from the determination result of the attack type (step S4).

When the attack type can be determined (step S4: Yes), the attack code analysis unit 123 executes emulation of the attack code on the basis of the attack type determined by the attack type determination unit 122. Then, the attack code analysis unit 123 performs attack code analysis processing for extracting the information output as the result of the emulation as a feature candidate at the time of success of the attack (step S5). Thereafter, the attack code analysis unit 123 stores the extracted feature candidates in the feature candidate DB 112.

The feature selection unit 124 selects a feature candidate from which a feature candidate unsuitable as a feature is excluded from the feature candidates stored in the feature candidate DB 112 as a feature to be used for determination of success/failure of an attack (step S6).

Then, the feature selection unit 124 determines whether or not a feature exists according to the selection result of the feature (step S7). For example, when all feature candidates are excluded, the feature selection unit 124 determines that no feature exists.

When there is a feature (step S7: Yes), the feature selection unit 124 stores the feature used for determination of success/failure of the selected attack in a feature DB 114. The success/failure determination unit 125 determines whether the response from the web server 1 includes the features stored in the feature DB 114 (step S8). The success/failure determination unit 125 determines whether the attack was successful or not by matching the features stored in the feature DB 114 with the response from the web server 1 that is the target of the determination of the success or failure of the attack.

When the response from the web server 1 includes the features stored in the feature DB 114 (step S8: Yes), the success/failure determination unit 125 determines that the attack to the web server 1 is successful. Then, the success/failure determination unit 125 transmits a message for notifying success of attack to the web server 1 to an external device (not shown) such as a manager terminal, and notifies a manager of the web server 1 of the message (step S9).

On the other hand, when the response from the web server 1 does not include the feature stored in the feature DB 114 (step S8: No), the success/failure determination unit 125 determines that the attack to the web server 1 has failed. Then, the success/failure determination unit 125 transmits a message for notifying a failure of an attack to the web server 1 to an external device (not shown) such as a manager terminal, and notifies a manager of the web server 1 of the message (step S10).

On the other hand, when the attack type cannot be determined (step S4: No) or when the feature does not exist (step S7: No), the success/failure determination unit 125 notifies a manager of the fact that the success/failure determination of the attack cannot be performed (step S11).

### [Effect of Information Collection Processing]

As described above, the alert verification device 10 according to the present embodiment receives an alert at the time of detecting an attack by the attack detection apparatus 3 such as WAF, and acquires communication data satisfying the acquisition condition generated from the received alert from the packet capture device 4 holding the duplication of the communication data. Then, the alert verification device 10 determines an attack type by using communication data associated with the acquired alert, emulates an attack code to extract a feature of a response, and when the response having the extracted feature is output from the web server 1, it is determined that the attack is successful. Thus, since the alert verification device 10 performs parsing the communication data associated with the alert to determine the success/failure of the attack, the alert verification device 10 can determine the success/failure of the attack by less parsing processing than parsing processing of all the communication data to the web server 1. Therefore, the alert verification device 10 reduces a parsing processing load of a communication packet without modification of an existing system and collection of definition of an attack and vulnerability information, it is possible to determine success or failure of an attack to the web server 1.

### Second Embodiment

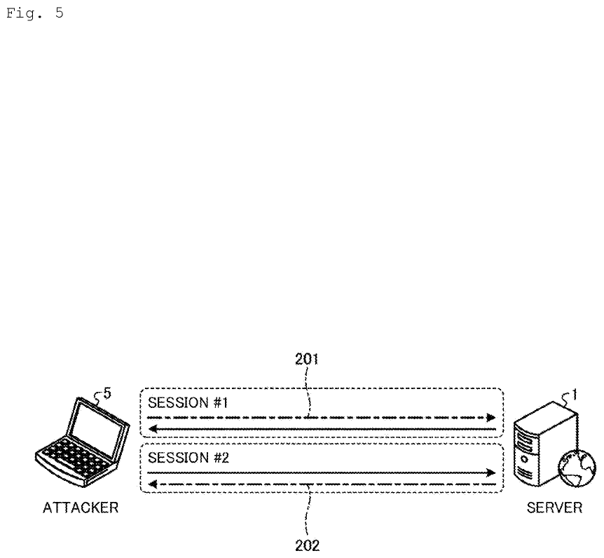

FIG. 5 is a diagram showing a second order attack according to a second embodiment. The attack to the web server 1 includes a second order attack targeting vulnerability which needs to be confirmed across the registration function and the reference function. For example, the case of analyzing the second order attack as shown in FIG. 5 will be described. In the session #1, the attack detection apparatus 3 such as WAF detects the attack request 201, but in the session #2, it is considered a case that the request is not determined as an attack. In this case, although the attack request 201 and the response 202 are attacks intended by the attacker, in the alert verification device 10 described in the first embodiment, the response 202 may not be a target of the attack success/failure determination of the alert verification technique.

Therefore, the communication data acquisition unit 121 according to the present embodiment generates a communication data acquisition condition from an alert, and performs the following processing in addition to the processing of acquiring the communication data satisfying the generated acquisition condition from the packet capture device 4. However, the communication data acquisition unit 121 may perform the following processing instead of the processing for acquiring communication data satisfying the acquisition condition of the communication data generated from the alert.

A generation unit 132 specifies a session in which the attack is detected from the alert acquired by the reception unit 131. Next, the generation unit 132 generates an acquisition condition by using information capable of identifying a communication source and a communication destination such as an IP address in the identified session. That is, the generation unit 132 generates the acquisition condition on the basis of information specifying a communication source or a communication destination in a first session in which the alert has occurred.

The acquisition unit 133 acquires communication data for a fixed time from the occurrence of the alert according to the acquisition condition generated by the generation unit 132. That is, the acquisition unit 133 acquires communication data matching the acquisition condition even for a first session and a second session subsequent to the first session from the packet capture device 4.

For example, when an attack by the attack request 201 is detected and the attack detection apparatus 3 issues an alert, the generation unit 132 identifies the session #1by the attack request 201 when the attack is detected from the alert. Then, the generation unit 132 stores information for identifying a communication partner of the web server 1 such as an IP address of a communication target device 5 of the session #1. For example, the generation unit 132 stores “the source IP address 192.168.0.1 and the destination IP address 10.0.0.1” of the session #1.

Then, the acquisition unit 133 acquires communication data matched information to identify the communication target device 5 from the packet capture device 4 at a fixed interval during a fixed time from the occurrence of the alert, and transmits the communication data to the attack type determination unit 122. For example, the acquisition unit 133 acquires an HTTP request and an HTTP response of “a transmission source IP address 192.168.0.1 and a transmission destination IP address 10.0.0.1” from the packet capture device 4 at 5 minutes intervals for one hour.

Here, if the success/failure determination unit 125 determines that the attack failed for session #1, the communication data acquisition unit 121 may perform the above processing.

Thus, the alert verification device 10 can determine that the attack is successful by the response 202 in the session #2 in which the attack request is not detected even when determining that the attack is failed in the session #1 in which the attack request 201 is detected.

As described above, the alert verification device 10 according to the present embodiment acquires the communication data between the communication target device 5 attacking and the web server 1 for sessions subsequent to the session in which the attack is detected, and determines whether the attack is successful or not. Thus, the success or failure of the attack can be determined even for the second order attack, and the security of the web server 1 can be improved.

### Third Embodiment

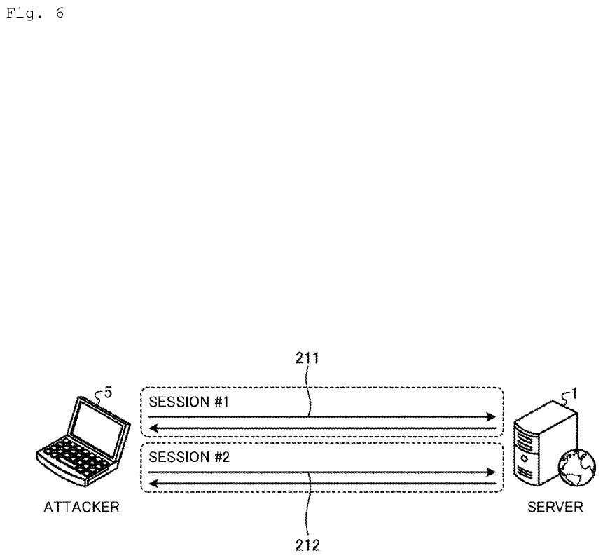

FIG. 6 shows an attack across a plurality of sessions in a third embodiment. An attack over a plurality of sessions such as blind SQL injection exists in the attack to the web server 1. For example, an explanation will be given of the case of analyzing an attack over a plurality of sessions as shown in FIG. 6. In this case, it is conceivable that the attack detection apparatus 3 does not detect the requests 211 and 212 as the attack requests in both of the sessions #1 and #2. In this case, in the alert verification device 10 described in the first embodiment, communication of sessions #1 and #2 may not be a target of attack success/failure determination.

Therefore, the communication data acquisition unit 121 according to the present embodiment generates a communication data acquisition condition from an alert, and performs the following processing in addition to the processing of acquiring the communication data satisfying the generated acquisition condition from the packet capture device 4. However, the communication data acquisition unit 121 may perform the following processing instead of the processing for acquiring communication data satisfying the acquisition condition of the communication data generated from the alert.

The generation unit 132 generates an acquisition condition on the basis of a predefined attack code. Then, the acquisition unit 133 acquires communication data corresponding to the acquisition condition generated by the generation unit 132 from the packet capture device 4 and transmits the communication data to the attack type determination unit 122.

For example, the generation unit 132 generates an acquisition condition for acquiring an HTTP request and an HTTP response that match a predefined regular expression (for example, “Yd+=Yd+” (where Yd+ represents that numerals are followed by one character or more) and the like). An acquisition unit 133 acquires an HTTP request and an HTTP response matching a preliminarily defined regular expression from the packet capture device 4 at a fixed interval such as a five-minute interval, and transmits the HTTP request and the HTTP response to the attack type determination unit 122.

As described above, the alert verification device 10 according to the present embodiment can also set the sessions #1 and #2 in which the requests 211 and 212 are not detected as attacks by the attack detection apparatus 3 as targets of attack success/failure determination processing. Thus, it is possible to determine the success or failure of an attack even for an attack extending over a plurality of sessions such as blind SQL injection, and to improve the security of the web server 1.

### Fourth Embodiment

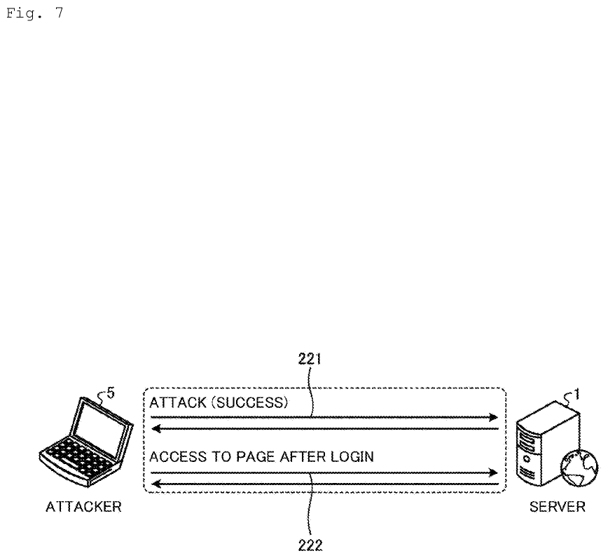

FIG. 7 is a diagram showing a login bypass attack according to a fourth embodiment. The attack to the web server 1 includes a login bypass attack for bypassing authentication and logging in. For example, the case of analyzing the login attack as shown in FIG. 7 will be described. In this case, the information entered by the request 221 is attack on the login page, however, it is generally not information for an attack. Further, the request 222 for accessing to the page after the login is also not determined as an attack by the attack detection apparatus 3. Therefore, if the login page is not identified, the communication may not be a target of the attack success/failure determination by the alert verification device 10 described in the first embodiment.

Therefore, the communication data acquisition unit 121 according to the present embodiment generates a communication data acquisition condition from an alert, and performs the following processing in addition to the processing of acquiring the communication data satisfying the generated acquisition condition from the packet capture device 4. However, the communication data acquisition unit 121 may perform the following processing instead of the processing for acquiring communication data satisfying the acquisition condition of the communication data generated from the alert.

The generation unit 132 generates an acquisition condition from a path portion or the like of a URL of a predefined login page. That is, the generation unit 132 generates the acquisition condition on the basis of information on a login page in the web server 1 which is a monitoring target device. Then, the acquisition unit 133 acquires communication data related to the login page from the packet capture device 4 according to the acquisition condition generated by the generation unit 132, and transmits the communication data to the attack type determination unit 122.

For example, the generation unit 132 receives designation of a path portion (for example, /login.php) which is a candidate for a login page in advance. Then, the generation unit 132 generates an acquisition condition for acquiring an HTTP request and an HTTP response including the “/login.php” in the path portion of the URL. An acquisition unit 133 acquires an HTTP request and an HTTP response including “login.php” to a path portion of the URL from a packet capture device 4 according to the acquisition condition generated by the generation unit 132, and transmits the HTTP request and the HTTP response to an attack type determination unit 122.

The generation unit 132 may acquire the information of the login page by the following method without receiving the designation of the path portion of the URL of the login page in advance. For example, the generation unit 132 stores a path portion and the like of the URL determined to be a login page when attack success/failure determination is performed by using communication data satisfying an acquisition condition generated from an alert. The generation unit 132 may generate the acquisition condition from a path portion and the like of the stored URL.

As described above, the alert verification device 10 according to the present embodiment can also make the communication in the login bypass attack which is not detected as an attack by the attack detection apparatus 3 as the object of the attack success/failure determination processing. Thus, the success or failure of the attack can be determined even for the login bypass attack, and the security of the web server 1 can be improved.

### Fifth Embodiment

The following describes a fifth embodiment. There is a case where it is desired to perform attack success/failure determination for a specific HTTP request and an HTTP response defined in advance, that is, specific communication data defined in advance, without using alert information of the attack detection apparatus 3.

Therefore, the generation unit 132 of the communication data acquisition unit 121 according to the present embodiment generates the acquisition condition from the information defined in advance, that is, the information for extracting the specific communication data defined in advance. Then, the acquisition unit 133 of a communication data acquisition unit 121 acquires communication data corresponding to the acquisition condition generated by the generation unit 132 from the packet capture device 4 and transmits the communication data to the attack type determination unit 122.

For example, if access to the path portion of a specific URL (e.g., /example.html) and the like is to be a target of attack success/failure determination of the alert verification technique, the generation unit 132 acquires information of “/example.html” that is the path portion of the specific URL, in advance. Then, the generation unit 132 generates an acquisition condition for acquiring an HTTP request including “/example.html” and an HTTP response in the path portion of the URL. The acquisition unit 133 acquires an HTTP request and an HTTP response including “/example.html” in a path portion of the URL from the packet capture device 4 according to the acquisition condition generated by the generation unit 132.

As described above, the alert verification device 10 according to the present embodiment acquires communication data on the basis of information defined in advance. Thus, the attack success/failure determination can be performed for a specific HTTP request and an HTTP response defined in advance, and the security of the web server 1 can be improved.

### Sixth Embodiment

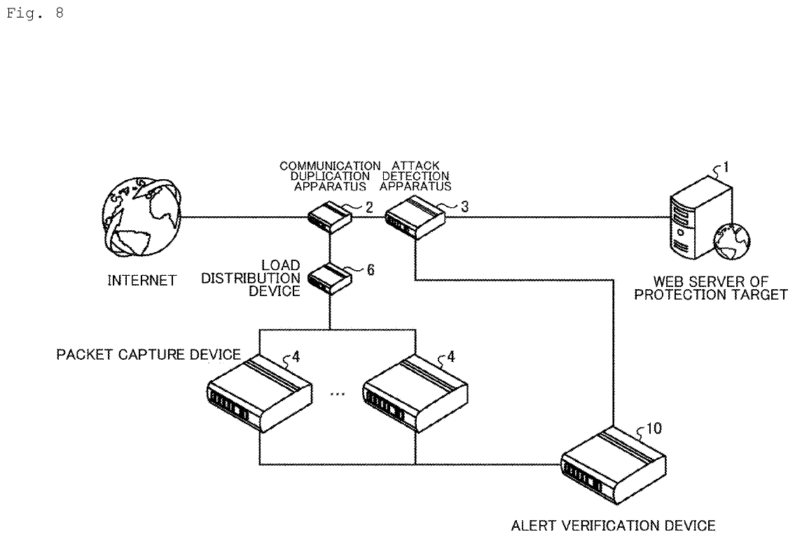

FIG. 8 is a system configuration diagram according to a sixth embodiment. As shown in FIG. 8, the system according to the present embodiment is provided with a load distribution device 6, and a plurality of packet capture devices 4 is arranged. In the system according to the present embodiment, communication data acquisition processing is performed in a distributed manner.

A plurality of packet capture devices 4 is connected to the load distribution device 6. The load distribution device 6 receives duplicates of communication data sent from the Internet to Web server 1 generated by communication duplication apparatus 2. Then, the load distribution device 6 distributes so as to be almost equally sent to each packet capture device 4 and transmits the duplicate of the communication data.

Each of the packet capture devices 4 receives a copy of the communication data from the load distribution device 6. Then, the packet capture device 4 accumulates and stores the communication data acquired respectively.

The alert verification device 10 is connected to each of the plurality of packet capture devices 4. An acquisition unit 133 of a communication data acquisition unit 121 in the alert verification device 10 identifies and acquires communication data matching an acquisition condition of data created on the basis of an alert from communication data held by each packet capture device 4. That is, the acquisition unit 133 acquires communication data from a plurality of packet capture devices 4 that distribute and hold communication data in communication performed by the web server 1, which is a monitoring target device.

As described above, the system according to the present embodiment distributes and transmits replicated communication data to a plurality of the packet capture devices 4 and causes to store them. Thus, the attack success/failure determination processing can be quickly performed in an environment where a larger amount of traffic flows, and security can be improved even in the web server 1 where a large amount of traffic flows.

### Modification Example

In the above-described embodiments, the communication to be monitored for determining whether or not the attack is successful has been described by taking an HTTP request and an HTTP response as examples, but there is no particular limitation as long as the communication has information for determining whether or not the attack is successful. For example, the alert verification device 10 may perform attack success/failure determination processing with another protocol such as FTP (File Transfer Protocol) as a monitoring target.

### [System Configuration, Etc.]

Each component of each illustrated device is a functional conceptual component and does not necessarily need to be physically configured as illustrated in the drawings. In other words, a specific form of distribution and integration of the respective devices is not limited to the form illustrated in the drawings, and all or some of the devices can be distributed or integrated functionally or physically in any units according to various loads, use situations, and the like. Furthermore, all or some of processing functions to be performed in each device can be realized by a CPU (Central Processing Unit) and a program analyzed and executed by the CPU, or can be realized as hardware using a wired logic.

In addition, among the respective processing steps described in the embodiment, all or a part of processing steps described as being automatically performed can be manually performed or, alternatively, all or a part of processing steps described as being manually performed can be automatically performed by known methods. Furthermore, information including processing procedures, control procedures, specific names, various data and parameters having been described above or shown in the drawings may be arbitrarily changed unless otherwise described.

Although the above embodiments have been described with reference to the tap configuration system as an example, the present invention is not limited to this, but an in-line configuration in which the alert verification device 10 is arranged between the attack detection apparatus 3 and the web server 1 and the alert verification device 10 is directly connected to the web server 1 which is a determination object of success or failure of an attack may be adopted. In each of the above embodiments, the communication duplication apparatus 2 is arranged to copy communication data such as tap, but when the attack detection apparatus 3 has a function of duplicating communication data, the packet capture device 4 is connected to the attack detection apparatus 3, and the attack detection apparatus 3 may duplicate the communication data and transmit it to the packet capture device 4.

### [Program]

Further, it can be implemented by installing a program that implements the functions of the alert verification device 10 described in the above embodiment into a desired information processing device (computer). For example, the information processing device can function as the alert verification device 10 by causing the information processing device to execute the program provided as package software or online software. The information processing device referred to here includes a desktop or notebook personal computer. In addition, a category of the information processing device includes mobile communication terminals such as smartphones, mobile phones and PHS (Personal Handyphone System), and further PDA (Personal Digital Assistants). Also, the alert verification device 10 may be implemented in a cloud server.

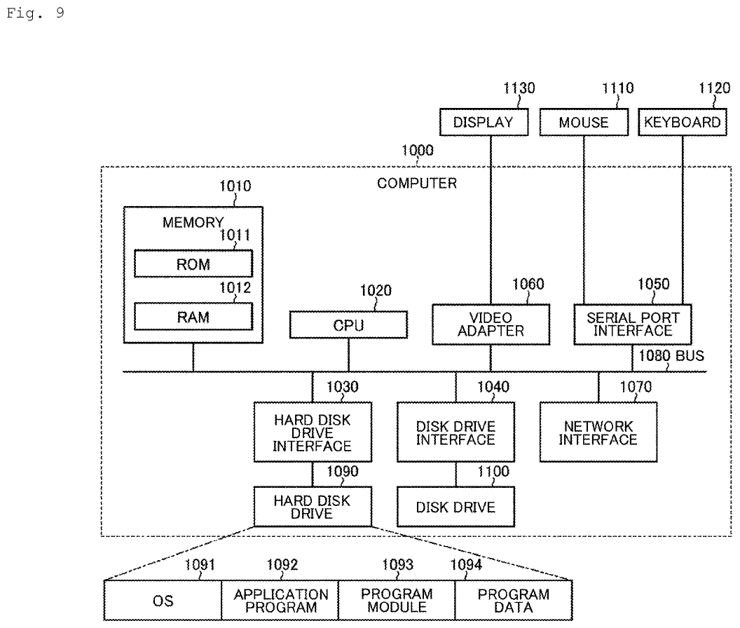

FIG. 9 shows an example of a computer executing an alert verification program for the attack success/failure determination processing. As shown in FIG. 9, for example, a computer 1000 has a memory 1010, a CPU 1020, a hard disk drive interface 1030, a disk drive interface 1040, a serial port interface 1050, a video adapter 1060, and a network interface 1070. These units are connected to one another via a bus 1080.

The memory 1010 includes a ROM (Read Only Memory) 1011 and a RAM (Random Access Memory) 1012. The ROM 1011 stores, for example, a boot program such as a BIOS (Basic Input Output System). The hard disk drive interface 1030 is connected to the hard disk drive 1090. The disk drive interface 1040 is connected to a disk drive 1100. A removable storage medium, such as a magnetic disk or an optical disk, is inserted into the disk drive 1100, for example. A mouse 1110 and the keyboard 1120 are connected to the serial port interface 1050, for example. A display 1130 is connected to the video adapter 1060, for example.

The hard disk drive 1090 stores, for example, an OS 1091, an application program 1092, a program module 1093, and program data 1094. In other words, an alert verification program defining each processing step of the alert verification device 10 which has functions equivalent to those of the alert verification device 10 is implemented as the program module 1093 which describes a code that can be executed by the computer. The program module 1093 is stored in, for example, the hard disk drive 1090. For example, the hard disk drive 1090 stores a program module 1093 for executing processing similar to the functional configuration of the alert verification device 10. The hard disk drive 1090 may be replaced with an SSD (Solid State Drive).

Further, configuration data to be used in the processing of the embodiment described above is stored as the program data 1094 in, for example, the memory 1010 or the hard disk drive 1090. Then, the CPU 1020 reads the program module 1093 or the program data 1094 stored in the memory 1010 or the hard disk drive 1090 into the RAM 1012 as necessary, and executes the processing of the above-described embodiment.

Further, the program module 1093 and the program data 1094 are not limited to being stored in the hard disk drive 1090 and may also be stored in, for example, a removable storage medium to be read out by the CPU 1020 via the disk drive 1100 or the like. Alternatively, the program module 1093 and the program data 1094 may be stored in another computer connected via a network (a local area network (LAN)), a wide area network (WAN), or the like). In addition, the program module 1093 and the program data 1094 may be read by the CPU 1020 from the other computer via the network interface 1070.

### REFERENCE SIGNS LIST

1 web server
2 Communication duplication apparatus
3 Attack detection apparatus
4 Packet capture device
10 Alert verification device
11 Storage unit
111 Attack type keyword list
112 Feature candidate DB
113 Request/response DB
114 Feature DB
121 Communication data acquisition unit
122 Attack type determination unit
123 Attack code analysis unit
124 Feature selection unit
125 Success/failure determination unit

1. An alert verification device, comprising:
receiving an alert transmitted from an attack detection apparatus, wherein the attack detection apparatus detects an attack on a monitoring target device;
generating an acquisition condition of communication data to be acquired on the basis of the received alerts;
acquiring the communication data, wherein the communication data matches the generated acquisition condition from a packet capture device, and the packet capture device holding data transmitted and received by the monitoring target device; and
determining success or failure of the attack on the basis of the acquired communication data.

2. The alert verification device according to claim 1, wherein the generating an acquisition condition further comprises generating the acquisition condition on the basis of information specifying a communication source or a communication destination in a first session in which the alert has occurred, and
the acquiring further comprises acquiring communication data, wherein the communication data match the acquisition condition from the packet capture device for the first session, a second session, and subsequent sessions.

3. The alert verification device according to claim 1, wherein the generating further comprises generating the acquisition condition on the basis of a predefined attack code.

4. The alert verification device according to claim 1, wherein the generating further comprises generating g the acquisition condition on the basis of information of a login page in the monitoring target device.

5. The alert verification device according to claim 1, wherein the generating further comprises generating u the acquisition condition on the basis of information for extracting predefined specific communication data.

6. The alert verification device according to claim 1, wherein the acquiring further comprises acquiring communication data from a plurality of packet capture devices that receive in distributed manner and hold the communication data respectively in communication performed by the monitoring target device.

7. A method for verifying an alert, comprising:
receiving an alert transmitted from an attack detection apparatus that detects an attack on the monitoring target device;
generating an acquisition condition of communication data to be acquired on the basis of the received alert;
acquiring the communication data matching the generated acquisition condition from a packet capture device, and the packet capture device holding data transmitted and received by the monitoring target device; and
determining success or failure of the attack on the basis of the acquired communication data.

8. A computer-readable non-transitory recording medium storing a computer-executable program instructions that when executed by a processor cause a computer system to execute operations comprising:
receiving an alert transmitted from an attack detection apparatus that detects an attack on the monitoring target device;
generating an acquisition condition of communication data to be acquired on the basis of the received alert;
acquiring the communication data matching the acquisition condition generated from a packet capture device, and the packet capture device holding data transmitted and received by the monitoring target device; and
determining success or failure of the attack on the basis of the communication data acquired.

9. The alert verification device according to claim 2, wherein the generating further comprises generating the acquisition condition on the basis of a predefined attack code.

10. The method according to claim 7, wherein the generating an acquisition condition further comprises generating the acquisition condition on the basis of information specifying a communication source or a communication destination in a first session in which the alert has occurred, and
the acquiring further comprises acquiring communication data, wherein the communication data match the acquisition condition from the packet capture device for the first session, a second session, and subsequent sessions.

11. The method according to claim 7, wherein the generating further comprises generating the acquisition condition on the basis of a predefined attack code.

12. The method according to claim 7, wherein the generating further comprises generating the acquisition condition on the basis of information of a login page in the monitoring target device.

13. The method according to claim 7, wherein the generating further comprises generating the acquisition condition on the basis of information for extracting predefined specific communication data.

14. The method according to claim 7, wherein the acquiring further comprises acquiring communication data from a plurality of packet capture devices that receive in distributed manner and hold the communication data respectively in communication performed by the monitoring target device.

15. The method according to claim 10, wherein the generating further comprises generating the acquisition condition on the basis of a predefined attack code.

16. The computer-executable non-transitory recording medium according to claim 8, wherein the generating an acquisition condition further comprises generating the acquisition condition on the basis of information specifying a communication source or a communication destination in a first session in which the alert has occurred, and the acquiring further comprises acquiring communication data, wherein the communication data match the acquisition condition from the packet capture device for the first session, a second session, and subsequent sessions.

17. The computer-executable non-transitory recording medium according to claim 8, wherein the generating further comprises generating the acquisition condition on the basis of a predefined attack code.

18. The computer-executable non-transitory recording medium according to claim 8, wherein the generating further comprises generating the acquisition condition on the basis of information of a login page in the monitoring target device.

19. The computer-executable non-transitory recording medium according to claim 8, wherein the generating further comprises generating the acquisition condition on the basis of information for extracting predefined specific communication data.

20. The computer-executable non-transitory recording medium according to claim 8, wherein the acquiring further comprises acquiring communication data from a plurality of packet capture devices that receive in distributed manner and hold the communication data respectively in communication performed by the monitoring target device.
